(19) United States
(12) Patent Application Publication
(10) Pub. No.: US 2008/0122973 A1
(43) Pub. Date: May 29, 2008

(54) Detection method of generation sequence of interlace picture and interlace/progressive conversion method and device

(75) Inventors: Mari Iwasaki, Fukuoka (JP); Hideki Matsuoka, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/907,825

(22) Filed: Oct. 17, 2007

(30) Foreign Application Priority Data
Nov. 28, 2006 (JP) JP2006-320428

(51) Int. Cl. H04N 7/01

(52) U.S. Cl. 348/448; 348/E07.003

(57) ABSTRACT

A method for detecting a generation sequence of an interlace picture signal for interlace/progressive conversion includes a step for performing motion detection for each pixel by a two-field difference with respect to a picture signal of the n-th field (n is an integer), so as to obtain a two-time statistic value from the number of pixels having a motion, a step for obtaining a one-time statistic value from an accumulated value of one-field differences for pixels that are detected to have a motion by the two-field difference with respect to the picture signal of the n-th field, and a step for detecting whether or not a generation sequence of an input picture signal is an edit sequence in which a progressive picture is edited for generation, by using the obtained two-time statistic value and the one-time statistic value.

### BACKGROUND OF THE INVENTION

1. Field of the Invention

The present invention relates to a method for detecting a generation sequence of an interlace picture for interlace/progressive conversion with respect to an interlace picture signal, and an interlace/progressive conversion method, as well as a detection device and a conversion device.

2. Description of the Prior Art

In general, a flat display panel such as a liquid crystal display (LCD) or a plasma display panel (PDP) has a screen that is made up of a picture signal of progressive scanning (or sequential scanning), which may be referred to as a “progressive picture” or a “progressive signal” in this description. In order that the flat display panel can display a picture signal of interlaced scanning (hereinafter, may be referred to as an “interlace picture” or an “interlace signal”) that is used by a CRT or the like, an IP conversion device that performs an interlace/progressive conversion (IP conversion) is used.

The IP conversion device has to decide which generation sequence was used for generating the interlace picture to be converted in order to obtain high image quality of the progressive picture. If the generation sequence is specified, the progressive picture can be synthesized and produced by an optimal method corresponding to the generation sequence.

Conventionally, 22 pull down sequence and 32 pull down sequence are known as the generation sequence when the interlace picture is generated (see Japanese unexamined patent publication No. 2002-57993).

The 22 pull down sequence is used in the case where a commercial film or the like of 30 Hz is converted into an interlace picture of 60 fields. In the 22 pull down sequence, n (n is an integer) frames of a progressive picture is converted into (2×n) fields of an interlace picture.

More specifically, as shown in FIGS. 7A-7C, a picture signal SV of each frame FM of a progressive picture VP is repeated two times each in each frame FM of an interlace picture VI. Concerning the repeat, FIG. 7B shows a case where the repeat is performed in the order of TOP and BOTTOM (TFF), and FIG. 7C shows the opposite case where the repeat is performed in the order of BOTTOM and TOP (BFF). In either case, two fields FD having the same contents are arranged in one frame FM.

The 32 pull down sequence is used in a case where a cinema film or the like of 24 Hz is converted into an interlace picture of 60 fields. In the 32 pull down sequence, n (n is an integer) frames of a progressive picture is converted into (2×n+1) fields of an interlace picture.

More specifically, as shown in FIGS. 8A and 8B, two frames FM of a progressive picture VP is converted into five fields FD. First, a picture signal SV of each frame FM of the progressive picture VP is repeated two times each in the frame FM of an interlace picture VI. Further, a first field FD (picture signal SV) is arranged repeatedly as a third field (a repeat field) FDr in every other frame FM of the interlace picture VI. In this case too, the field FD of the interlace picture VI has a bottom field (BOTTOM) and a top field (TOP) arranged alternately.

Since the interlace picture VI converted by the 32 pull down sequence or the 22 pull down sequence is originally derived from the progressive picture VP, an optimal IP conversion can be performed by a process such that the original progressive picture VP is reproduced.

The conventional IP conversion device detects whether the generation sequence of the input interlace picture VI is the 32 pull down sequence or the 22 pull down sequence, and it reproduces the progressive picture VP by an optimal method corresponding to the detected sequence, so that the IP conversion is performed.

For example, if it is the 32 pull down sequence or the 22 pull down sequence, a progressive reproducing portion reproduces the original progressive picture VP. If it is other generation sequence, a high image quality IP converting portion performs a process such that a progressive picture VP having a high image quality as much as possible can be obtained.

However, the conventional IP conversion device detects the generation sequence with respect to only the 32 pull down sequence and the 22 pull down sequence as described above, and other generation sequences are not detected. Therefore, in the case of a generation sequence except the 32 pull down sequence and the 22 pull down sequence, an optimal IP conversion is not performed, so the image quality is lowered as a result.

For example, as shown in FIG. 9, when three frames FM of the progressive picture VP are converted into seven fields FD of the interlace picture VI, an optimal IP conversion is not performed because it is not the 32 pull down sequence or the 22 pull down sequence. Therefore, image quality of the obtained progressive picture VP is lowered.

### SUMMARY OF THE INVENTION

An object of the present invention is to enable detection of a generation sequence also with respect to an interlace picture that is generated by a generation sequence except the 32 pull down sequence and the 22 pull down sequence, so as to improve image quality of a progressive picture that is generated by interlace/progressive conversion.

A detection method according to one aspect of the present invention is a method for detecting a generation sequence of an interlace picture signal for interlace/progressive conversion. The method includes the steps of determining a two-field difference that is a difference between the n-th field (n is an integer) and the (n−2)th field as well as three one-field differences that are a difference between the n-th field and the (n−1)th field, a difference between the (n−1)th field and the (n−2)th field, and a difference between the (n−2)th field and the (n−3)th field, with respect to a picture signal of the n-th field, and detecting whether or not a generation sequence of the picture signal of the n-th field is an edit sequence in which a progressive picture is edited for generation, based on values of the two-field difference and the three one-field differences.

According to another aspect of the present invention, the method includes a step for performing motion detection for each pixel by a two-field difference with respect to a picture signal of the n-th field (n is an integer), so as to obtain a two-time statistic value from the number of pixels having a motion, a step for obtaining a one-time statistic value from an accumulated value of one-field differences for pixels that are detected to have a motion by the two-field difference with respect to the picture signal of the n-th field, and a step for detecting whether or not a generation sequence of an input picture signal is an edit sequence in which a progressive picture is edited for generation, by using the obtained two-time statistic value and the obtained one-time statistic value.

An interlace/progressive conversion method according to still another aspect of the present invention includes a first step for performing motion detection for each pixel by a two-field difference with respect to a picture signal of the n-th field (n is an integer) so as to obtain a two-time statistic value from the number of pixels having a motion, a second step for obtaining a one-time statistic value from an accumulated value of one-field differences for pixels that are detected to have a motion by the two-field difference with respect to the picture signal of the n-th field, a third step for determining one-time statistic values for the picture signals of the (n−1)th field and the (n−2)th field and for storing the same, a fourth step for comparing each of the two-time statistic value of the picture signal of the n-th field and the three one-time statistic values of the picture signals of the n-th field, the (n−1)th field and the (n−2)th field with a threshold value so as to decide whether or not a generation sequence of the picture signal of the n-th field is an edit sequence in which a progressive picture is edited for generation, in accordance with values thereof, and a fifth step for generating one frame by combining picture signals of two neighboring fields among the n-th field, the (n−1)th field and the (n−2)th field and for delivering the generated frame as a progressive picture signal, if it is decided that the generation sequence of the n-th field is the edit sequence.

Preferably, a bias of a difference between the two-time statistic values and a bias of a difference between the one-time statistic values are utilized, and the fourth step may include deciding that the generation sequence of the n-th field is the edit sequence if the two-time statistic value of the n-th field is larger than a second threshold value, and both the one-time statistic values of the n-th field and the (n−2)th field are larger than a first threshold value, and the one-time statistic value of the (n−1)th field is smaller than the first threshold value.

As to another embodiment, the fourth step may include deciding that the n-th field is a repeat field in the edit sequence if the two-time statistic value of the n-th field is smaller than a second threshold value, and both the one-time statistic values of the n-th field and the (n−1)th field are smaller than a first threshold value, and the one-time statistic value of the (n−2)th field is larger than the first threshold value, and a frame rate of the progressive picture from which the interlace picture is generated is calculated based on a period of the repeat field.

In this way, although it is detected that the generation sequence is the edit sequence by combining the bias of the one-time statistic value with the bias of the two-time statistic value, it is possible to use only the one-time statistic value, and it is possible to decide that the generation sequence is the edit sequence based on the repeat field.

### BRIEF DESCRIPTION OF THE DRAWINGS

FIG. 1 is a block diagram showing a structure of an IP conversion device according to the present invention.

FIG. 2 is a diagram showing an example of a structure of an edit sequence detecting portion.

FIG. 3 is a diagram showing an example of a structure of a two-time statistic value calculating portion.

FIG. 4 is a diagram showing an example of a structure of a one-time statistic value calculating portion.

FIG. 5 is a diagram showing an example of a structure of a decision processing portion.

FIG. 6 is a diagram showing an example of a structure of a progressive picture reproducing portion.

FIGS. 7A-7C are diagrams for explaining 22 pull down sequence.

FIGS. 8A and 8B are diagrams for explaining 32 pull down sequence.

FIG. 9 is a diagram showing an example of edit sequence based on a different frame rate.

FIG. 10 is a diagram for explaining an example of even field conversion in the edit sequence.

FIG. 11 is a diagram for explaining another example of the even field conversion in the edit sequence.

FIG. 12 is a diagram for explaining an example of odd field conversion in the edit sequence.

FIG. 13 is a diagram showing a relationship between a type of field and a statistic amount.

FIG. 14 is a flowchart showing a general flow of IP conversion in the IP conversion device.

FIG. 15 is a diagram for explaining a scene change picture.

FIG. 16 is a diagram for explaining a principle of detecting the scene change picture.

FIG. 17 is a diagram for explaining an example of a pseudo-edit sequence.

FIG. 18 is a diagram for explaining a characteristic of the pseudo-edit sequence.

FIG. 19 is a diagram showing an example of a structure of a progressive picture reproducing portion.

FIG. 20 is a diagram showing an example of a structure of the IP conversion device according to a sixth embodiment.

FIG. 21 is a diagram showing an example of a structure of the IP conversion device according to a seventh embodiment.

FIG. 22 is a diagram showing an example of a structure of the IP conversion device according to an eighth embodiment.

### DESCRIPTION OF THE PREFERRED EMBODIMENTS

The invention will now be described in detail with reference to the attached drawings.

### First Embodiment

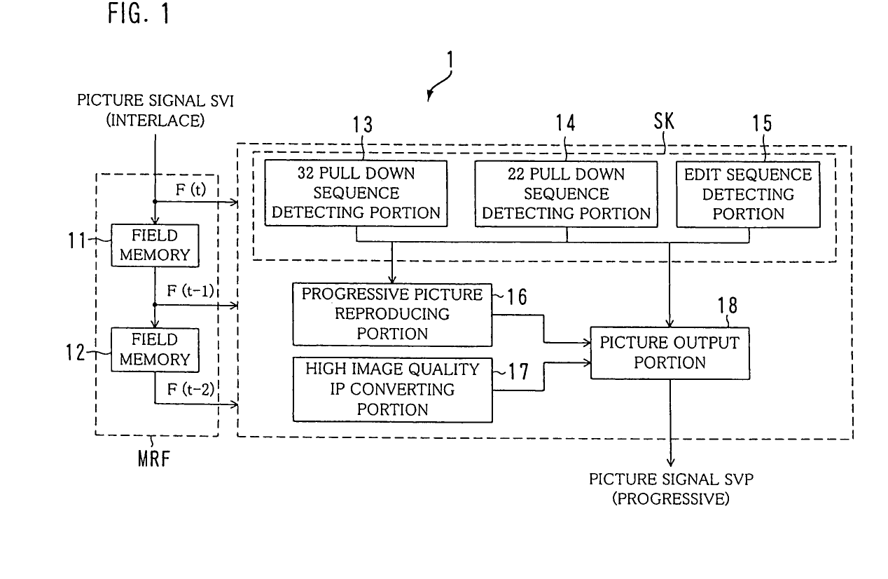

FIG. 1 is a block diagram showing a structure of an IP conversion device 1 according to the present invention.

The IP conversion device 1 of the present embodiment converts a picture signal (an image signal) SVI of an interlace picture VI into a picture signal (an image signal) SVP of a progressive picture VP. The IP conversion device 1 receives the interlace picture VI sequentially in real time for each field FD, and corresponding to it frames FM of the progressive picture VP are produced sequentially in real time. The IP conversion device 1 detects various generation sequences of the input interlace picture VI and delivers the progressive picture VP that is reproduced by an optimal method corresponding to the detected generation sequence.

As shown in FIG. 1, the IP conversion device 1 is made up of field memories 11 and 12, a 32 pull down sequence detecting portion 13, a 22 pull down sequence detecting portion 14, an edit sequence detecting portion 15, a progressive picture reproducing portion 16, a high image quality IP converting portion 17, a picture output portion 18 and the like.

Each of the two field memories 11 and 12 memorizes one field of the input picture signal SVI. The field memory 11 memorizes a field F(t−1) that is one field before the input field F(t) of the picture signal SVI, while the other field memory 12 memorizes a field F(t−2) that is two fields before the input field F(t) of the picture signal SVI. Therefore, by using the field memories 11 and 12, successive three fields of the picture signal SVI including the input field F(t) can be extracted at the same time.

For example, supposing that an input field F(t) at any time point is a n-th field (n is an integer), (n−1)th field of the picture signal SVI can be extracted from the field memory 11, while (n−2)th field of the picture signal SVI can be extracted from the field memory 12. This portion that can extract three fields F(t), F(t−1) and F(t−2) of the picture signal SVI may be referred to as a “field memory portion MRF”.

The 32 pull down sequence detecting portion 13 detects whether or not the generation sequence is the 32 pull down sequence with respect to the input picture signal SVI. If the 32 pull down sequence detecting portion 13 detects that the generation sequence is the 32 pull down sequence, a detection signal KS13 is produced.

The 22 pull down sequence detecting portion 14 detects whether or not the generation sequence is the 22 pull down sequence with respect to the input picture signal SVI. If the 22 pull down sequence detecting portion 14 detects that the generation sequence is the 22 pull down sequence, a detection signal KS14 is produced.

The 32 pull down sequence detecting portion 13 and the 22 pull down sequence are known conventionally as the background art described above, and a detection method thereof, contents of the output detection signals KS13 and KS14, and the IP conversion method in that case are also known. Various known techniques can be selected and used.

The edit sequence detecting portion 15 is a characteristic portion in the present embodiment, and it detects a generation sequence of the picture signal SVI that is generated by editing the progressive picture. Furthermore, the generation sequence that generated the picture signal SVI by editing the progressive picture is referred to as an “edit sequence” in this description. Therefore, the edit sequence includes also the 32 pull down sequence and the 22 pull down sequence, and it includes various usual or special generation sequences except them. For example, it includes a generation sequence of a frame rate different from the 32 pull down sequence or the 22 pull down sequence.

If the edit sequence detecting portion 15 detects that the generation sequence is the edit sequence, a detection signal KS15 including sequence information DS, combination information DK and the like is delivered. The progressive picture VP is reproduced based on the detection signal KS15. The detail will be described later.

The 32 pull down sequence detecting portion 13, the 22 pull down sequence detecting portion 14 and the edit sequence detecting portion 15 may be referred to as a “sequence detecting portion SK”.

The progressive picture reproducing portion 16 synthesizes one frame FM using two fields of the picture signal SVI delivered from the field memory portion MRF and produces it as a progressive picture VP. The field that is used for the synthesis is corrected if necessary, or a field that is generated by interpolation is used. Also when the sequence detecting portion SK detects that the generation sequence is the edit sequence, the progressive picture reproducing portion 16 generates the progressive picture VP. The progressive picture reproducing portion 16 performs a process in accordance with the detection signals KS13-K15. For example, when the progressive picture VP is generated based on the detection signal KS15, two fields that are used for synthesizing the frame FM are selected in accordance with the combination information DK.

The progressive picture reproducing portion 16 usually generates and delivers one frame FM with respect to one field FD of the interlace picture VI. Therefore, if the interlace picture VI is 60 fields per second, a progressive picture VP of 60 frames per second is delivered.

The high image quality IP converting portion 17 is used in the case where the progressive picture reproducing portion 16 cannot reproduce the progressive picture VP. The high image quality IP converting portion 17 can be constituted by using a motion compensation IP conversion technique or other various known techniques, for example.

The picture output portion 18 selects and delivers an optimal picture among output pictures from the progressive picture reproducing portion 16 or the high image quality IP converting portion 17 in accordance with the detection signals KS13-K15 from the sequence detecting portion SK.

Next, the principle for the edit sequence detecting portion 15 to detect whether or not the generation sequence is the edit sequence will be described.

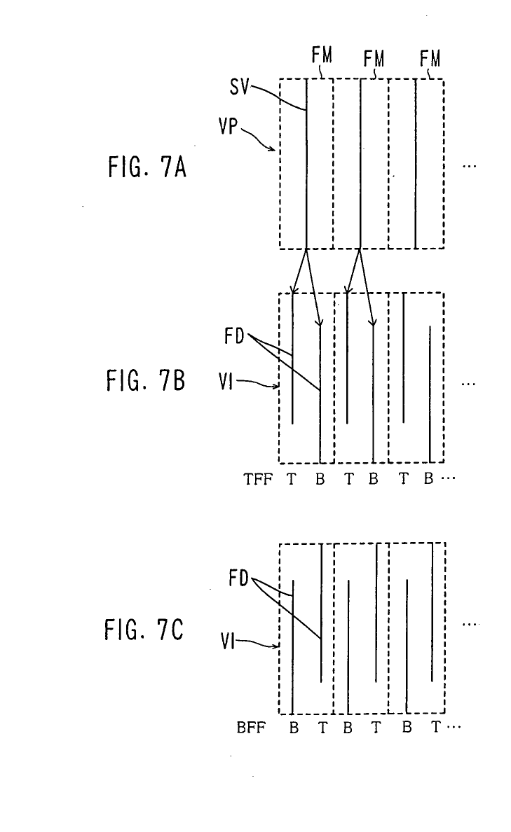

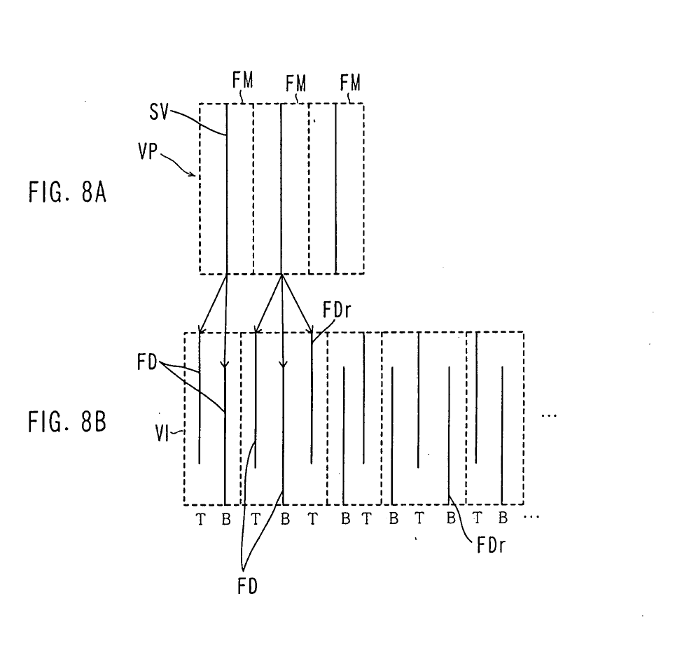

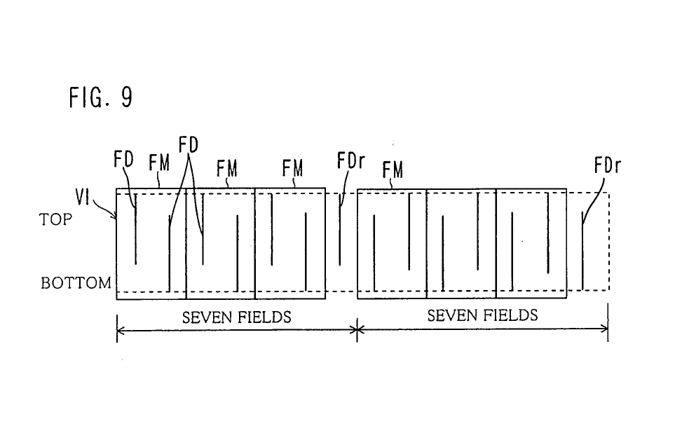

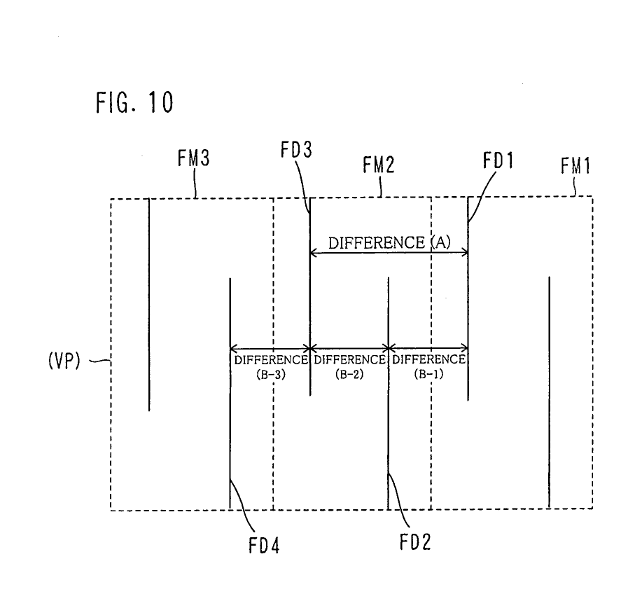

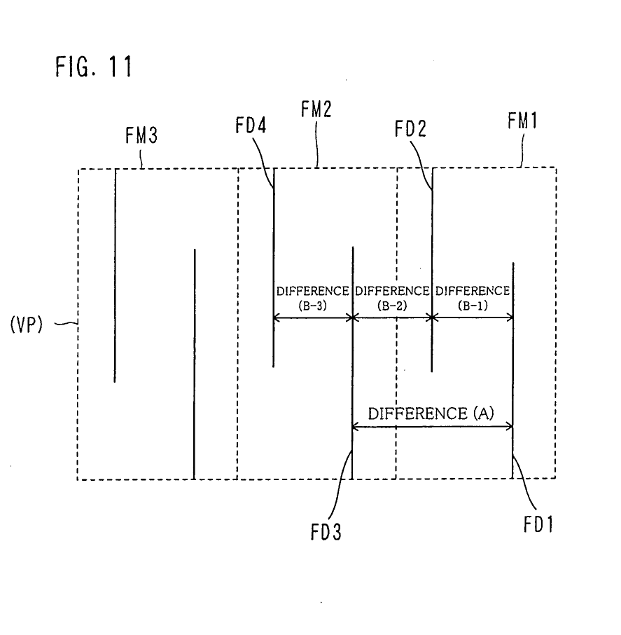

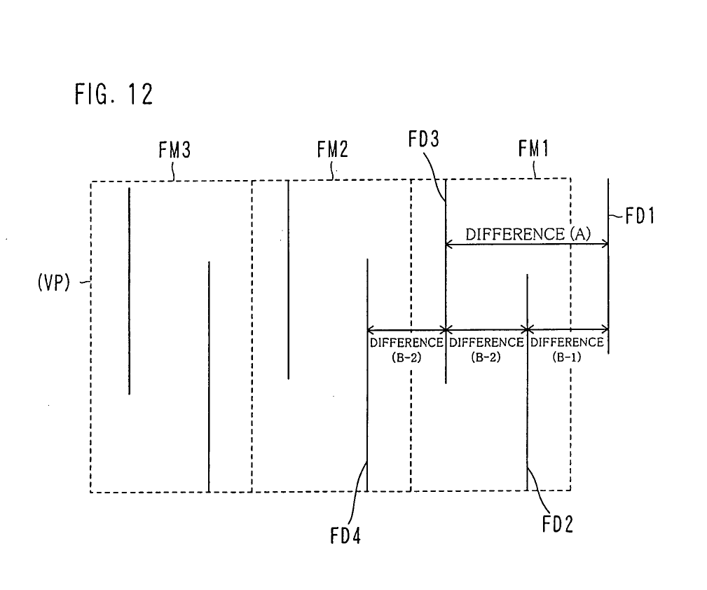

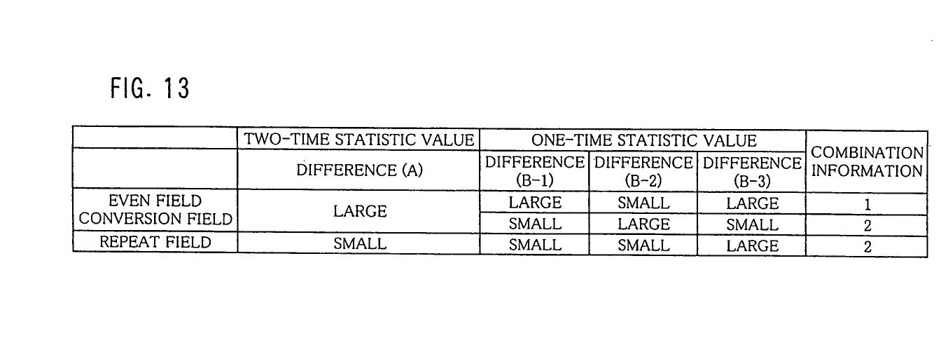

FIGS. 7A-7C are diagrams for explaining 22 pull down sequence, FIGS. 8A and 8B are diagrams for explaining 32 pull down sequence, FIG. 9 is a diagram showing an example of edit sequence based on a different frame rate, FIG. 10 is a diagram for explaining an example of even field conversion in the edit sequence, FIG. 11 is a diagram for explaining another example of the even field conversion in the edit sequence, FIG. 12 is a diagram for explaining an example of odd field conversion in the edit sequence, and FIG. 13 is a diagram showing a relationship between a type of field and a statistic amount.

As described above, the interlace picture VI generated by the edit sequence depends on the two conversion methods below.

(1) Convert n frames FM of the progressive picture VP into (2×n) fields FD (even field conversion).

(2) Convert n frames FM of the progressive picture VP into (2×n+1) fields FD (odd field conversion).

Among these methods, the method (1) (even field conversion) generates the interlace picture VI from the progressive picture VP, so a half of neighboring two fields FD is generated from the same progressive picture VP. In this case, a difference between the generated two fields FD is small because they are pictures at the same time point. On the contrary, a difference between two fields FD which has another field between them is large because they are pictures at different time points.

As shown in FIGS. 10-12, the noted field FD is referred to as a field FD1, and preceding fields FD are referred to as fields FD2, FD3 and FD4 in turn. The field FD1 is a top field of the frame FM1, and the fields FD2 and FD3 are a bottom field and a top field of the preceding frame FM2. The field FD4 is a bottom field of the further preceding frame FM3.

As shown in FIG. 10, a difference (A) between the current field FD1 and the field FD3 that is two fields before is large because they are based on different frames FM. The current field FD1 and the preceding field FD2 are based on different frames FM. The field FD3 that is two fields before and the preceding field FD4 are also based on different frames FM. Therefore, differences (B−1) and (B−3) between their pictures are both large. However, the field FD2 that is one field before and the preceding field FD3 are based on the same frame FM, so a difference (B−2) between their pictures is small.

As shown in FIG. 11, the current field FD1 and the field FD3 that is two fields before the same are based on different frames FM, so a difference (A) between their pictures is large. The current field FD1 and the preceding field FD2 are based on the same frame FM. The field FD3 that is two fields before and the preceding field FD4 are also based on the same frame FM. Therefore, differences (B−1) and (B−3) between their pictures are both small. The field FD2 that is one field before and the preceding field FD3 are based on different frames FM, so a difference (B−2) of their picture is large.

As described above, in the even field conversion, a difference (A) is always large, and the differences (B−1) and (B−3) have the same value, but the difference (B−2) has a different value. The edit sequence detecting portion 15 uses these differences (A), (B−1), (B−2) and (B−3) so as to detect accurately that it is generated by the edit sequence and that the edit sequence has used the even field conversion.

Further, in the above-mentioned method (2) (odd field conversion), the field FD is made up of an even number of fields that are generated by the even field conversion and one repeat field. If the noted field FD is the repeat field, there is a high probability that three neighboring fields FD including the repeat field are generated from the same progressive picture VP. In this case, differences among the three generated fields FD are small.

As shown in FIG. 12, the current field FD1 and the field FD3 that is two fields before the same are based on the same frame FM, so a difference (A) between their pictures is small. The current field FD1 and the preceding field FD2 are based on the same frame FM. The field FD2 and the preceding field FD3 are also based on the same frame FM. Therefore, differences (B−1) and (B−2) between their pictures are both small. However, the field FD3 and the preceding field FD4 are based on different frames FM, so a difference (B−3) between their pictures is large. The repeat field in the edit sequence is detected by using such a property.

As described above, in the present embodiment, the above-mentioned difference (A) and differences (B−1), (B−2) and (B−3) are determined with respect to the noted field FD, and it is detected based on their values that the generation sequence is the edit sequence. The IP conversion device 1 of the present embodiment calculates the differences (A), (B−1), (B−2) and (B−3) as statistic values by the pixel. More specifically, the difference (A) is calculated as a “two-time statistic value”, and the differences (B−1), (B−2) and (B−3) are calculated as “one-time statistic values”.

The difference (A) may be referred to as a “two-field difference”, and each of the differences (B−1), (B−2) and (B−3) may be referred to as a “one-field difference”.

As shown in FIG. 13, in the case where the noted field FD1 is generated by the even field conversion and in the case where it is the repeat field, whether each of the two-time statistic value and the one-time statistic value is large or small is shown. When it is decided whether the statistic value is large or small, an appropriate threshold value is set so that it is decided whether or not the statistic value is larger than or equal to the threshold value.

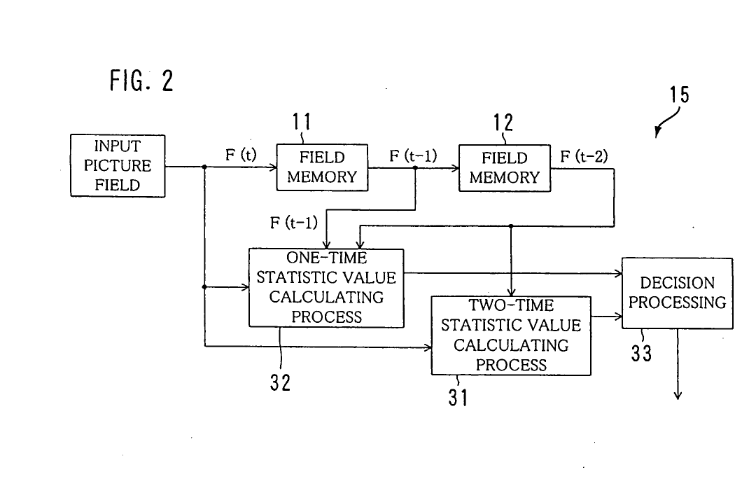

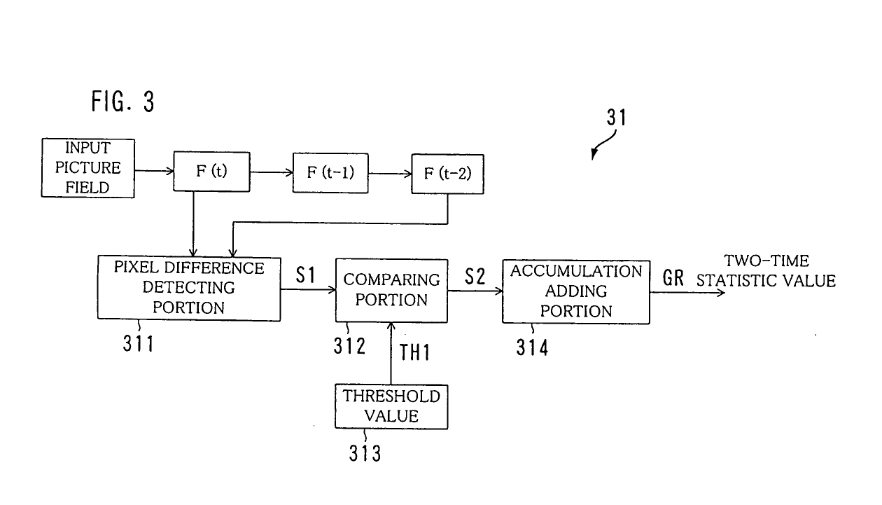

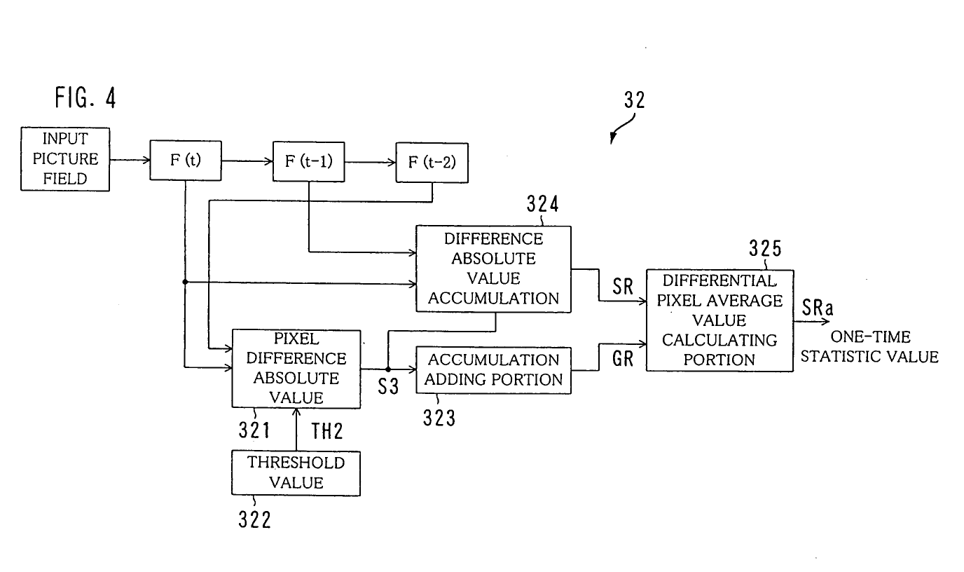

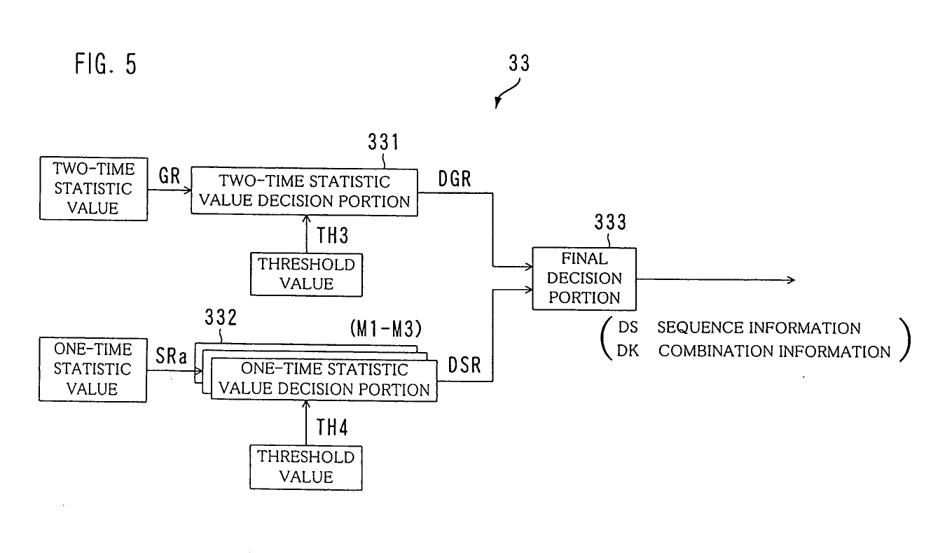

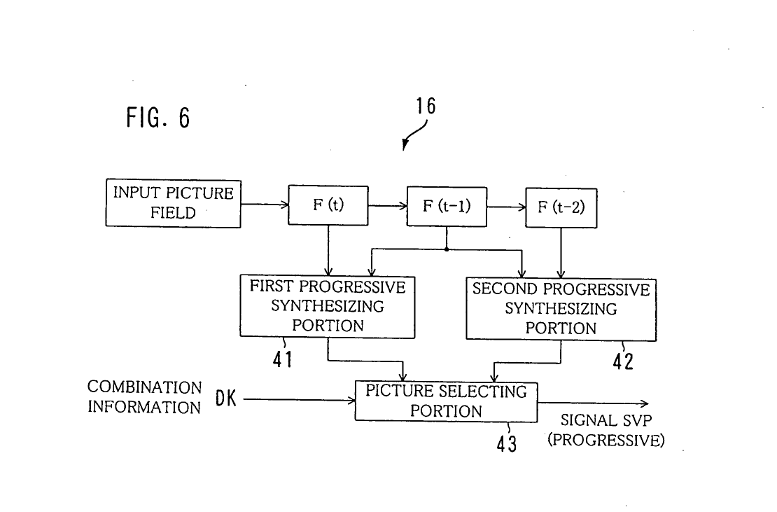

FIG. 2 is a diagram showing an example of a structure of an edit sequence detecting portion 15, FIG. 3 is a diagram showing an example of a structure of a two-time statistic value calculating portion, FIG. 4 is a diagram showing an example of a structure of a one-time statistic value calculating portion, FIG. 5 is a diagram showing an example of a structure of a decision processing portion, and FIG. 6 is a diagram showing an example of a structure of a progressive picture reproducing portion 16.

As shown in FIG. 2, the edit sequence detecting portion 15 is made up of a two-time statistic value calculating portion 31, a one-time statistic value calculating portion 32, a decision processing portion 33 and the like. In addition, a process performed by the edit sequence detecting portion 15 uses a field memory portion MRF such as the field memories 11 and 12.

The two-time statistic value calculating portion 31 calculates the difference (A) as the two-time statistic value as described above. More specifically, it performs motion detection for each pixel based on the two-field difference with respect to the input picture signal SVI of the n-th field and determines a sum value GR of the number of pixels having motions, which is regarded as the two-time statistic value.

The one-time statistic value calculating portion 32 calculates each of the differences (B−1), (B−2) and (B−3) as the one-time statistic value. More specifically, it accumulates absolute values of one-field differences for pixels that were decided to have motions by the two-field difference with respect to the input picture signal SVI of the n-th field so that an accumulated value SR is determined. Then, a differential pixel average value is obtained by dividing the accumulated value SR by the sum value GR and is regarded as the one-time statistic value.

The decision processing portion 33 uses the two-time statistic value and the three one-time statistic values for deciding whether or not it is an edit sequence. In accordance with the decision result, the detection signal KS15 including the sequence information DS and the combination information DK are delivered.

As shown in FIG. 3, the two-time statistic value calculating portion 31 includes a pixel difference detecting portion 311, a comparing portion 312, a threshold value storing portion 313 and an accumulation adding portion 314.

The pixel difference detecting portion 311 detects a difference between the field F(t) and the field F(t−2) for each pixel. In this case, for example, a difference of density gradation or brightness gradation is detected for each pixel.

The comparing portion 312 delivers a signal S2 only in the case where the absolute value of the difference signal S1 delivered from the pixel difference detecting portion 311 is larger than or equal to the threshold value TH1. More specifically, if the difference signal S1 is smaller than the threshold value TH1, it is not used as the statistic value.

This threshold value TH1 is set to an empirical value that is not affected by a minute noise or the like. For example, if gradation of the pixel is 0-255, it is set to a value of approximately 10-20. If it is the repeat field that is based on the same frame FM, the difference has to be zero so that the motion can be detected based on whether the difference is zero or not. But, considering an influence of a noise or the like, it is decided that there is a motion if the difference signal S1 is larger than or equal to the threshold value TH1.

The accumulation adding portion 314 adds and accumulates the number of times that the comparing portion 312 delivered the signal S2. In this way, the sum value GR of the number of pixels that have motions can be determined. The sum value GR is the two-time statistic value.

As shown in FIG. 4, the one-time statistic value calculating portion 32 includes a pixel difference detecting portion 321, a threshold value storing portion 322, an accumulation adding portion 323, a difference accumulating portion 324 and a differential pixel average value calculating portion 325.

The pixel difference detecting portion 321 detects a difference between the field F(t) and the field F(t−2) for each pixel similarly to the pixel difference detecting portion 311 described above. Then, similarly to the comparing portion 312 described above, the difference signal S3 is delivered only if the absolute value of the difference is larger than or equal to the threshold value TH2. The threshold value TH2 has the same purpose as the threshold value TH1 described above, and they can have the same value or different values. For example, if gradation of the pixel is 0-255 as the threshold value TH2, it is set to a value of approximately 10-30, more specifically to a value of approximately 20-30.

The accumulation adding portion 323 adds and accumulates the number of times that the pixel difference detecting portion 321 delivered the difference signal S3 similarly to the accumulation adding portion 314 described above. In this way, a sum value GR that is substantially the same as described above is obtained.

The difference accumulating portion 324 detects a difference between the field F(t) and the field F(t−1) for each pixel only with respect to the pixel for which the difference signal S3 is delivered, and the difference is added and accumulated. Here, not the number of times but a value of the difference is accumulated. The difference accumulating portion 324 delivers the accumulated value SR.

The differential pixel average value calculating portion 325 determines a differential pixel average value SRa that is obtained by dividing the accumulated value SR by the sum value GR, which is regarded as the one-time statistic value.

When the difference accumulating portion 324 determines the accumulated value SR, the difference is accumulated only with respect to the pixel for which the difference signal S3 is delivered. The reason is as follows. If the difference is accumulated with respect to all pixels, the characteristic that the one-time statistic value is small in the case where it is from the same progressive picture VP and is large in the case where it is from different progressive pictures VP may not appear in a picture having large variation in luminance, a fine natural picture having high precision, a picture having a minute motion of a subject, or the like. This is because that the difference between the field F(t) and the field F(t−1) that are derived from the same progressive picture VP includes an error in the space direction (within the picture), and that in the case of a simple difference value, a difference value due to a motion in the time direction and an error in the space direction are mixed and calculated.

Therefore, the fact that the two-field difference has little error in the space direction and has only a difference due to a motion in the time direction is utilized. Thus, the one-field difference is calculated only with respect to a pixel having a motion between the field F(t) and the field F(t−2), so that an error in the space direction can be reduced.

Note that although the above-mentioned method is preferable, it is possible to adopt a structure for using other methods for determining the accumulated value SR. In addition, although the value obtained by dividing the accumulated value SR by the sum value GR is regarded as the differential pixel average value SRa and as the one-time statistic value, it is possible not to divide the accumulated value SR by the sum value GR but to recognize the accumulated value SR itself as the one-time statistic value. In addition, it is also possible to regard a value obtained by multiplying the accumulated value SR by other appropriate coefficient or a value obtained by an appropriate function of the accumulated value SR or the like as the one-time statistic value.

As shown in FIG. 5, the decision processing portion 33 includes a two-time statistic value decision portion 331, a one-time statistic value decision portion 332, a final decision portion 333 and the like.

The two-time statistic value decision portion 331 decides that the two-time statistic value is “large” if the two-time statistic value that is delivered from the two-time statistic value calculating portion 31 is larger than the threshold value TH3, and then it sets large or small data DGR indicating that the two-time statistic value is large or small to “1”.

The threshold value TH3 in this case is set to an empirical value such that it can be decided correctly whether or not it is the repeat field without affected by a noise or the like. For example, since the two-time statistic value is the number of pixels having motions, a ratio of the number of pixels having motions to a value GRr obtained by dividing the two-time statistic value by the number of all pixels in one field is set as the threshold value TH3. In this case, for example, approximately a few percent is set as the threshold value TH3.

The one-time statistic value decision portion 332 has memories M1-M3 for storing three fields of one-time statistic values delivered from the one-time statistic value calculating portion 32. Each of the one-time statistic values with respect to the three fields F(t), F(t−1) and F(t−2) stored in the memories M1-M3 is compared with the threshold value TH4. If the one-time statistic value is larger than the threshold value TH4, it is decided that the one-time statistic value is “large”, and each of the large or small data DSR indicating that the one-time statistic value is large or small is set to “1”.

The threshold value TH4 in this case is set to an empirical value such that a conspicuous motion can be detected without affected by a noise or the like. For example, if gradation of the pixel is 0-255, it is set to a value of approximately 5-15.

The threshold values TH3 and TH4 that are used here correspond respectively to the second threshold value and the first threshold value in the present invention, both of which correspond to the threshold value in the step 4 in claim 3.

The final decision portion 333 decides the edit sequence with respect to the noted field F(t) based on the two types of large or small data DGR and DSR, and it delivers the detection signal KS15 that includes the sequence information DS and the combination information DK.

More specifically, the final decision portion 333 decides whether the noted field F(t) is a field FD generated by the even field conversion or a repeat field based on the relationship shown in the diagram of FIG. 13.

The sequence information DS becomes “1” when it is decided that the generation sequence is the edit sequence. In addition, as described later, the sequence information DS becomes “2” when it is decided to be a scene change picture VC. Otherwise, the sequence information DS becomes “0”. The combination information DK indicates a position of the field F(t) in the edit sequence.

Note that the edit sequence detecting portion 15 can detect the edit sequence also in the case of the 32 pull down sequence and the 22 pull down sequence. Therefore, if the 32 pull down sequence detecting portion 13 and the 22 pull down sequence detecting portion 14 are operating effectively, the edit sequence detecting portion 15 should not detect the edit sequence in that case.

Here, the differences (B−1), (B−2) and (B−3) are one-time statistic values of the fields F(t), F(t−1) and F(t−2), respectively.

For example, if the two-time statistic value is large and the differences (B−1) and (B−3) that are the one-time statistic values are large and the difference (B−2) is small, the field F(t) is decided to be a field that is generated by the edit sequence and to be a field that is generated by the even field conversion. In this case, the sequence information DS is set to “1”. In addition, since the field F(t) is a first field of the original progressive picture VP, the combination information DK is set to “1” that indicates a first order.

Further, also in the case where the two-time statistic value is large and the differences (B−1) and (B−3) that are the one-time statistic values are small and the difference (B−2) is large, similarly to the above-mentioned case, the field F(t) is decided to be a field that is generated by the edit sequence and to be a field that is generated by the even field conversion so that the sequence information DS is set to “1”. In addition, since the field F(t) is a second field of the original progressive picture VP,the combination information DK is set to “2” that indicates a second order.

In addition, if the two-time statistic value is small and the differences (B−1) and (B−2) that are the one-time statistic values are small and the difference (B−3) is large, the field F(t) is decided to be the repeat field so that the sequence information DS is set to “1”. Then, the combination information DK is set to “2” that indicates a second order.

Otherwise, the field F(t) is decided to be a field that is not generated by the edit sequence so that the sequence information DS is set to “0”.

In this way, the edit sequence detecting portion 15 decides whether or not the generation sequence is the edit sequence based on two types of statistic values including the two-time statistic value and the one-time statistic value. Therefore, if the interlace picture signal SVI is generated by the edit sequence, it can be detected correctly. In addition, even a different frame rate sequence can be detected easily.

Furthermore, if the two-time statistic value or the one-time statistic value is used by itself, it may be detected incorrectly in the case where a stop field is in the picture abruptly or in other cases. By deciding whether or not the generation sequence is the edit sequence based on the two types of statistic values, it can be detected effectively that the generation sequence is the edit sequence.

As shown in FIG. 6, the progressive picture reproducing portion 16 includes a first progressive synthesizing portion 41, a second progressive synthesizing portion 42, a picture selecting portion 43 and the like.

The first progressive synthesizing portion 41 performs progressive synthesis of the field F(t) and the field F(t−1) with a known method so as to generate one frame FM, which is delivered as a picture signal SVP.

The second progressive synthesizing portion 42 performs progressive synthesis of the field F(t−1) and the field F(t−2) with a known method so as to generate one frame FM, which is delivered as the picture signal SVP.

The picture selecting portion 43 selects either an output of the first progressive synthesizing portion 41 or an output of the second progressive synthesizing portion 42 in accordance with the combination information DK. More specifically, an output of the second progressive synthesizing portion 42 is selected if the combination information DK is “1”, while an output of the first progressive synthesizing portion 41 is selected if the combination information DK is “2”.

In this way, since the IP conversion device 1 of the present embodiment is equipped with the edit sequence detecting portion 15 adding to the 32 pull down sequence detecting portion 13 and the 22 pull down sequence detecting portion 14, it can detect the edit sequence of an interlace picture VI that has a frame rate different from those of the 32 pull down sequence and the 22 pull down sequence. Therefore, if the interlace picture VI is generated by editing the progressive picture, the generation sequence can be generated without depending on the frame rate thereof so that the progressive picture VP with high image quality can be reproduced based on the detection result.

Next, contents of the process performed by the IP conversion device 1 will be described with reference to a flowchart.

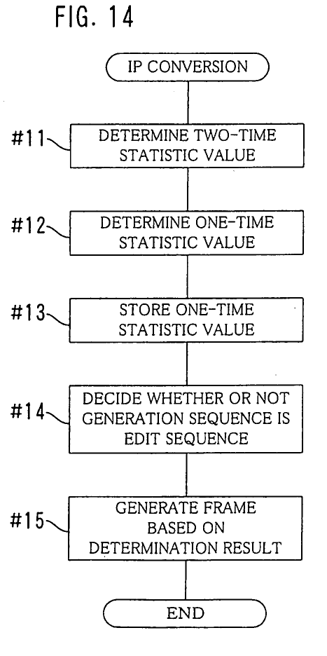

FIG. 14 is a flowchart showing a general flow of the IP conversion performed by the IP conversion device 1.

As shown in FIG. 14, the two-time statistic value is determined with respect to the picture signal SVI of the n-th field of the input interlace picture VI (#11). The one-time statistic value is determined with respect to the picture signal SVI of the n-th field (#12). The one-time statistic value is stored in advance so that the one-time statistic value can be obtained with respect to the total three fields (#13). It is decided whether or not the generation sequence is the edit sequence by using the two-time statistic value and the three one-time statistic values (#14). An appropriate reproduction method is selected based on the decision result, and the frame FM of the progressive picture VP is generated and delivered (#15).

Note that individual portions of the IP conversion device 1 and their functions can be realized by a hardware circuit or by software of an appropriate program that is executed by a CPU, a DSP or the like, or by a combination thereof.

Hereinafter, other embodiments will be described. The second and following embodiments described below fundamentally use the IP conversion device 1 described above in the first embodiment, so only different portions will be described.

### Second Embodiment

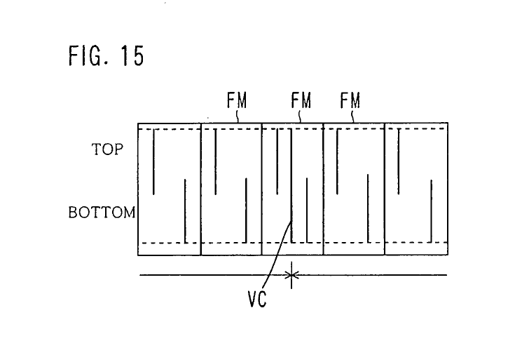

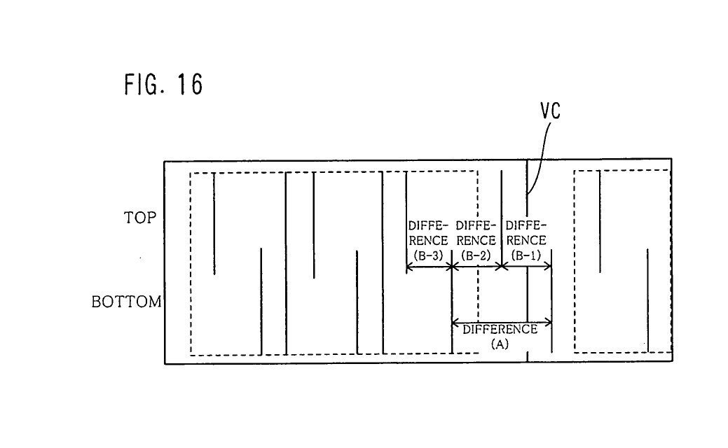

FIG. 15 is a diagram for explaining a scene change picture VC, and FIG. 16 is a diagram for explaining a principle of detecting the scene change picture VC.

In the second embodiment, a scene change picture VC having a scene change at some midpoint is also detected. The scene change picture VC is a picture produced by connecting and editing progressive pictures VP such as cinema pictures and commercial films.

The scene change picture VC has original interlace pictures only at the last field of the first scene and the first field of the second scene, and original progressive pictures before the last field of the first scene and after the first field of the second scene.

The scene change picture VC is a picture such that when it is connected at one field of the progressive picture in the editing process, the field becomes not a progressive picture.

In the scene change picture VC too, a difference, i.e., a motion between the field F(t−2) that is two fields before and the current field F(t) is large because they are pictures having different time points. In addition, a difference (a motion) between the current field F(t) and the field F(t−1) that is one field before or the field F(t−2) that is two fields before is also large because they are pictures having different time points. Utilizing this fact, the scene change picture VC is detected.

As shown in FIG. 16, utilizing the fact that the difference (A), differences (B−1) and (B−2) are large but the difference (B−3) between the field that is two fields before and the field that is three fields before is small because the picture is originally a progressive picture, it is decided to be the scene change picture VC.

If the scene change picture VC is decided, the edit sequence detecting portion 15 sets the sequence information DS to “2” that indicates the scene change picture VC. The picture output portion 18 selects the picture signal SVP of the high image quality IP converting portion 17 and delivers the same.

The high image quality IP converting portion 17 generates and delivers the progressive picture by using a field in which an interlace picture exists with respect to a field without the interlace picture, for example, so as to obtain an average value of upper and lower gradation values for scene change picture VC.

### Third Embodiment

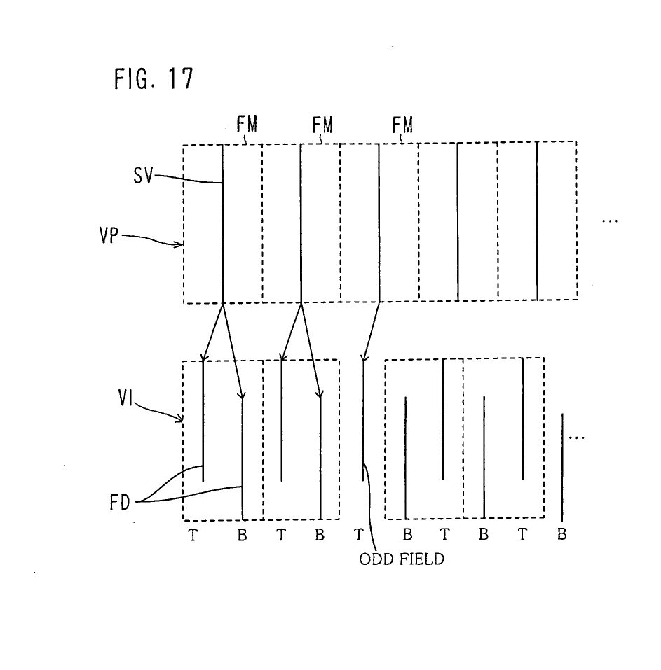

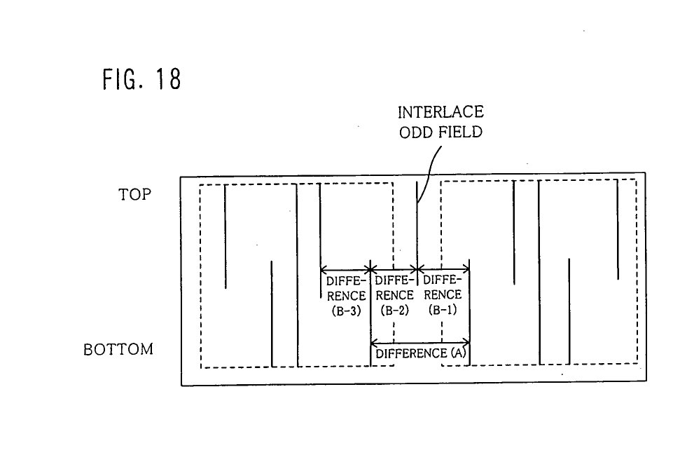

FIG. 17 is a diagram for explaining an example of a pseudo-edit sequence, and FIG. 18 is a diagram for explaining a characteristic of the pseudo-edit sequence.

In the third embodiment, a pseudo-edit sequence is also detected as the edit sequence. More specifically, in the odd field conversion described above, there is a rare case where n frames FM are converted into (2×n−1) field FD. This is the pseudo-edit sequence.

As shown in FIG. 17, each one frame FM is divided into two fields FD, but the last frame is made one field FD in the pseudo-edit sequence. This final frame is provided for each appropriate number of frames. In the example shown in FIG. 17, the final frame is provided for three frames each. The field that is generated from the final frame becomes the top field or the bottom field in accordance with the preceding and succeeding fields.

The IP conversion device 1 can also detect the pseudo-edit sequence.

The interlace picture VI generated by the pseudo-edit sequence is a picture in which the field F(t−2) that is two fields before and the current field F(t) have different time points, so a difference between them is large. In addition, the current field F(t) as well as the field F(t−1) that is one field before and the field F(t−2) that is two fields before have different time points, so a difference between them is large.

As shown in FIG. 18, the difference (A) and the differences (B−1) and (B−2) are large, while the difference (B−3) is small because the picture is originally a progressive picture. Utilizing this fact, it is detected that the generation sequence is the pseudo-edit sequence.

If the generation sequence is the pseudo-edit sequence, the edit sequence detecting portion 15 sets the sequence information DS to “1” that indicates the edit sequence. Further, it sets the combination information DK to “2” that indicates the second order. The picture output portion 18 selects the picture signal SVP of the progressive picture reproducing portion 16 and delivers the same.

In this way, as to the interlace picture VI generated by the pseudo-edit sequence, the progressive picture reproducing portion 16 reproduces the progressive picture.

### Fourth Embodiment

As a fourth embodiment, the frame rate is detected if the generation sequence is the edit sequence of the odd field conversion.

More specifically, if the edit sequence detecting portion 15 detects the repeat field, a frame rate of the progressive picture VP, from which the interlace picture VI is generated, is calculated based on a period of the repeat field. More concretely, the number of fields in the period in which the repeat field is generated is counted by a counter if the repeat field is detected, for example. If a value of the counter is “c”, the frame rate RF can be calculated by the following expression.

RF=60×((c/2)/(c+1))

For example, if a value of the counter is “14”, RF=60×7/15=28, so it is calculated that the original progressive picture VP is a picture of 28 Hz.

### Fifth Embodiment

As a fifth embodiment, the 32 pull down sequence detecting portion 13 is included in the edit sequence detecting portion 15.

More specifically, as described above, the edit sequence detecting portion 15 can detect the 32 pull down sequence, too. It is because that the 32 pull down sequence can be regarded as a case of a special frame rate in the edit sequence. In other words, since the detection performed by the edit sequence detecting portion 15 is equivalent to that the picture is a progressive picture with a repeat field, the 32 pull down sequence detecting portion 13 can be included in the edit sequence detecting portion 15.

Therefore, although a diagram of the fifth embodiment is omitted, it has a structure in which the 32 pull down sequence detecting portion 13 of the IP conversion device 1 shown in FIG. 1 is eliminated, and the edit sequence detecting portion 15 includes the function of detecting the 32 pull down sequence.

In addition, as a first variation of the fifth embodiment, the edit sequence detecting portion 15 includes both the 32 pull down sequence detecting portion 13 and the 22 pull down sequence detecting portion 14. As a second variation, the edit sequence detecting portion 15 includes both the 22 pull down sequence detecting portions 14. It is because the edit sequence detecting portion 15 can detect the 22 pull down sequence, too.

### Sixth Embodiment

As a sixth embodiment, the structure of the progressive picture reproducing portion is simplified and a progressive picture VP that was synthesized one field before is used in accordance with the combination information DK.

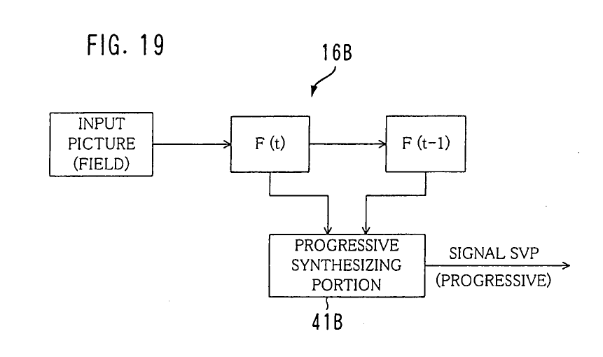

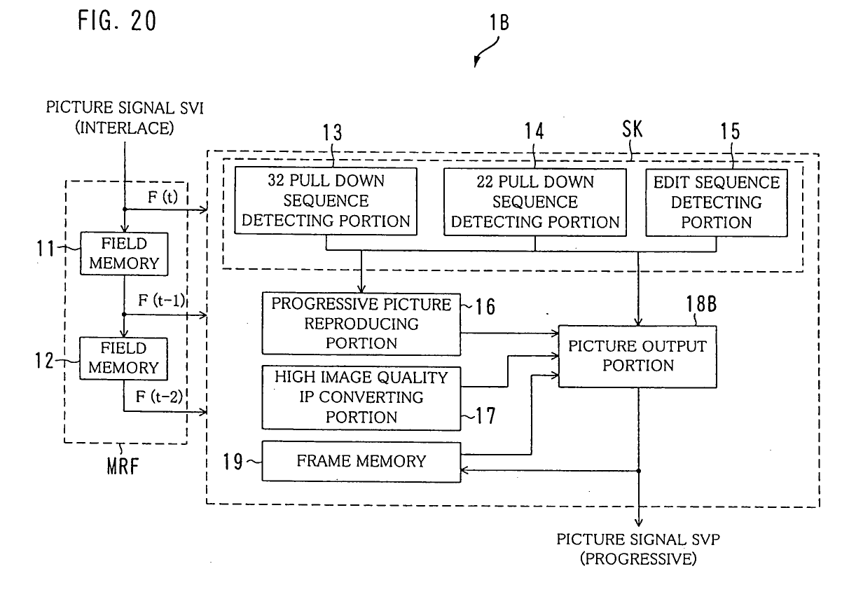

FIG. 19 is a block diagram showing an example of a structure of a progressive picture reproducing portion 16B, and FIG. 20 is a diagram showing an example of a structure of the IP conversion device 1B according to the sixth embodiment.

As shown in FIG. 19, the progressive picture reproducing portion 16B is made up of a single progressive synthesizing portion 41B. The progressive synthesizing portion 41B combines the field F(t) with the field F(t−1) so as to synthesize one frame FM, which is delivered as a picture signal SVP.

As shown in FIG. 20, the IP conversion device 1B is provided with a frame memory 19. The frame memory 19 stores temporarily the picture signal SVP delivered by the picture output portion 18B. Therefore, the frame memory 19 accumulates the picture signal SVP of the frame that was synthesized corresponding to the field before one field.

If the edit sequence detecting portion 15 detects that the generation sequence is the edit sequence, the progressive picture reproducing portion 16B delivers the picture signal SVP from the progressive picture reproducing portion 16B in the same manner as the case of the first embodiment. In this case, however, if the combination information DK is “2”, the picture signal SVP that is accumulated in the frame memory 19 before is delivered again as the progressive picture VP. Thus, a progressive picture VP with higher image quality can be delivered.

### Seventh Embodiment

As a seventh embodiment, there is provided an interpolating portion 20 that interpolates the progressive picture VP by an interpolation process.

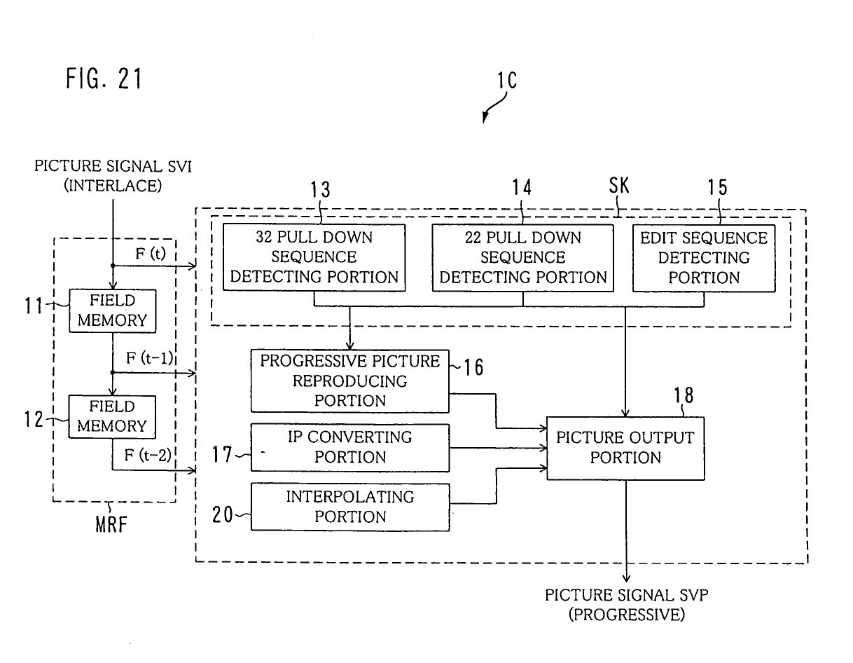

FIG. 21 is a diagram showing an example of a structure of the IP conversion device 1C according to the seventh embodiment.

As shown in FIG. 21, the interpolating portion 20 generates, from a picture signal SVI of the current field F(t), a picture signal SVI of the other field that is necessary for the progressive synthesis by the interpolation process. More specifically, the interpolating portion 20 synthesizes the picture signal SVP of one frame from one field by the interpolation process.

Since the interpolating portion 20 exists, it is able to select the picture signal SVP generated by the interpolating portion 20 and to deliver the same when the edit sequence detecting portion 15 detects that the generation sequence is the edit sequence.

### Eighth Embodiment

As an eighth embodiment, a frame rate converting portion 21 is provided.

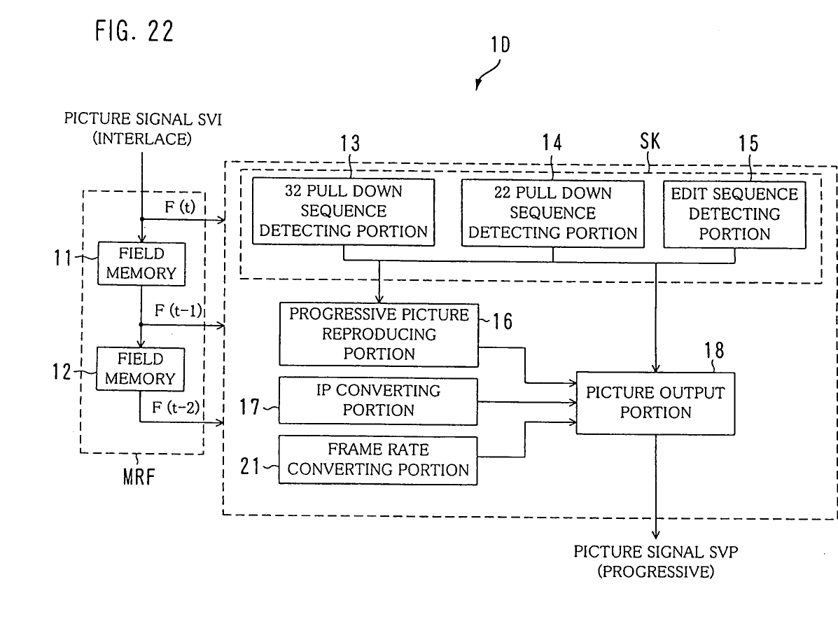

FIG. 22 is a diagram showing an example of a structure of the IP conversion device 1D according to the eighth embodiment.

As shown in FIG. 22, the frame rate converting portion 21 estimates lacking fields from the preceding field and generates the same if the original progressive picture VP of the interlace picture VI has a frame rate RF smaller than 60 Hz.

If the edit sequence detecting portion 15 detects that the generation sequence is the edit sequence and calculates the frame rate RF, the frame rate converting portion 21 generates lacking fields by performing the interpolation.

In the first to the eighth embodiment described above, the structure and the number of the entire or a part of the edit sequence detecting portion 15, the progressive picture reproducing portion 16, the field memory portion MRF, the sequence detecting portion SK, and the IP conversion device 1, 1B, 1C or 1D, the process contents, the process order, and the like can be modified if necessary in accordance with the spirit of the present invention.

Although embodiments of the present invention are described above with reference to some examples, the present invention is not limited to the above-mentioned embodiments but can be carried out in various embodiments.

While example embodiments of the present invention have been shown and described, it will be understood that the present invention is not limited thereto, and that various changes and modifications may be made by those skilled in the art without departing from the scope of the invention as set forth in the appended claims and their equivalents.

What is claimed is:

1. A method for detecting a generation sequence of an interlace picture signal for interlace/progressive conversion, the method comprising:
determining a two-field difference that is a difference between the n-th field (n is an integer) and the (n−2)th field as well as three one-field differences that are a difference between the n-th field and the (n−1)th field, a difference between the (n−1)th field and the (n−2)th field, and a difference between the (n−2)th field and the (n−3)th field, with respect to a picture signal of the n-th field; and
detecting whether or not a generation sequence of the picture signal of the n-th field is an edit sequence in which a progressive picture is edited for generation, based on values of the two-field difference and the three one-field differences.

2. A method for detecting a generation sequence of an interlace picture signal for interlace/progressive conversion, the method comprising:
a step for performing motion detection for each pixel by a two-field difference with respect to a picture signal of the n-th field (n is an integer), so as to obtain a two-time statistic value from the number of pixels having a motion;
a step for obtaining a one-time statistic value from an accumulated value of one-field differences for pixels that are detected to have a motion by the two-field difference with respect to the picture signal of the n-th field; and
a step for detecting whether or not a generation sequence of an input picture signal is an edit sequence in which a progressive picture is edited for generation, by using the obtained two-time statistic value and the obtained one-time statistic value.

3. A method for detecting a generation sequence of an interlace picture signal for interlace/progressive conversion, the method comprising:
a step for performing motion detection for each pixel by a two-field difference with respect to a picture signal of the n-th field (n is an integer) so as to determine a sum value GR of the number of pixels having a motion as a two-time statistic value;
a step for determining an accumulated value SR of absolute values of one-field differences of pixels that are regarded to have a motion by the two-field difference with respect to the picture signal of the n-th field and for obtaining a differential pixel average value as a one-time statistic value by dividing the accumulated value SR by the sum value GR;
a step for determining one-time statistic values for picture signals of the (n−1)th field and the (n−2)th field and for storing the values; and
a step for detecting whether or not a generation sequence of the picture signal of the n-th field is an edit sequence in which a progressive picture is edited for generation by using the two-time statistic value for the picture signal of the n-th field and the three one-time statistic values for the picture signals of the n-th field, the (n−1)th field and the (n−2)th field.

4. An interlace/progressive conversion method for converting an interlace picture signal into a progressive picture signal, the method comprising:
a first step for performing motion detection for each pixel by a two-field difference with respect to a picture signal of the n-th field (n is an integer) so as to obtain a two-time statistic value from the number of pixels having a motion;
a second step for obtaining a one-time statistic value from an accumulated value of one-field differences for pixels that are detected to have a motion by the two-field difference with respect to the picture signal of the n-th field;
a third step for determining one-time statistic values for the picture signals of the (n−1)th field and the (n−2)th field and for storing the same;
a fourth step for comparing each of the two-time statistic value of the picture signal of the n-th field and the three one-time statistic values of the picture signals of the n-th field, the (n−1)th field and the (n−2)th field with a threshold value so as to decide whether or not a generation sequence of the picture signal of the n-th field is an edit sequence in which a progressive picture is edited for generation, in accordance with values thereof; and
a fifth step for generating one frame by combining picture signals of two neighboring fields among the n-th field, the (n−1)th field and the (n−2)th field and for delivering the generated frame as a progressive picture signal, if it is decided that the generation sequence of the n-th field is the edit sequence.

5. The interlace/progressive conversion method according to claim 4, wherein the fourth step includes deciding that the generation sequence of the n-th field is the edit sequence if the two-time statistic value of the n-th field is larger than a second threshold value, and both the one-time statistic values of the n-th field and the (n−2)th field are larger than a first threshold value, and the one-time statistic value of the (n−1)th field is smaller than the first threshold value.

6. The interlace/progressive conversion method according to claim 5, wherein the fifth step includes combining the picture signal of the (n−1)th field with the picture signal of the (n−2)th field so as to generate the frame.

7. The interlace/progressive conversion method according to claim 4, wherein the fourth step includes deciding that the generation sequence of the n-th field is the edit sequence if the two-time statistic value of the n-th field is larger than a second threshold value, and both the one-time statistic values of the n-th field and the (n−2)th field are smaller than a first threshold value, and the one-time statistic value of the (n−1)th field is larger than the first threshold value.

8. The interlace/progressive conversion method according to claim 4, wherein the fourth step includes deciding that the generation sequence of the n-th field is the edit sequence if the two-time statistic value of the n-th field is smaller than a second threshold value, and both the one-time statistic values of the n-th field and the (n−1)th field are smaller than a first threshold value, and the one-time statistic value of the (n−2)th field is larger than the first threshold value.

9. The interlace/progressive conversion method according to claim 7, wherein the fifth step includes combining the picture signal of the n-th field with the picture signal of the (n−1)th field so as to generate the frame.

10. The interlace/progressive conversion method according to claim 4, wherein
the fourth step includes deciding that the n-th field is a repeat field in the edit sequence if the two-time statistic value of the n-th field is smaller than a second threshold value, and both the one-time statistic values of the n-th field and the (n−1)th field are smaller than a first threshold value, and the one-time statistic value of the (n−2)th field is larger than the first threshold value, and
a frame rate of the progressive picture from which the interlace picture is generated is calculated based on a period of the repeat field.

11. The interlace/progressive conversion method according to claim 4, wherein
the fourth step includes deciding that the n-th field is a scene change picture if the two-time statistic value of the n-th field is larger than a second threshold value, and both the one-time statistic values of the n-th field and the (n−1)th field are larger than a first threshold value, and the one-time statistic value of the (n−2)th field is smaller than the first threshold value, and
the frame generated by high image quality IP conversion is delivered as a progressive picture signal if the n-th field is a scene change picture.

12. A detection device for detecting a generation sequence of an interlace picture signal for interlace/progressive conversion, the device comprising:
a portion that determines a two-field difference that is a difference between the n-th field (n is an integer) and the (n−2)th field as well as three one-field differences that are a difference between the n-th field and the (n−1)th field, a difference between the (n−1)th field and the (n−2)th field, and a difference between the (n−2)th field and the (n−3)th field, with respect to a picture signal of the n-th field; and
a portion that detects whether or not a generation sequence of the picture signal of the n-th field is an edit sequence in which a progressive picture is edited for generation, based on values of the two-field difference and the three one-field differences.

13. A detection device for detecting a generation sequence of an interlace picture signal for interlace/progressive conversion, the device comprising:
a portion that performs motion detection for each pixel by a two-field difference with respect to a picture signal of the n-th field (n is an integer), so as to obtain a two-time statistic value from the number of pixels having a motion;
a portion that obtains a one-time statistic value from an accumulated value of one-field differences for pixels that are detected to have a motion by the two-field difference with respect to the picture signal of the n-th field; and
a portion that detects whether or not a generation sequence of an input picture signal is an edit sequence in which a progressive picture is edited for generation, by using the obtained two-time statistic value and the one-time statistic value.

14. A detection device for detecting a generation sequence of an interlace picture signal for interlace/progressive conversion, the device comprising:
a portion that performs motion detection for each pixel by a two-field difference with respect to a picture signal of the n-th field (n is an integer) so as to determine a sum value GR of the number of pixels having a motion as a two-time statistic value;
a portion that determines an accumulated value SR of absolute values of one-field differences of pixels that are regarded to have a motion by the two-field difference with respect to the picture signal of the n-th field and obtains a differential pixel average value as a one-time statistic value by dividing the accumulated value SR by the sum value GR;
a portion that determines one-time statistic values for picture signals of the (n−1)th field and the (n−2)th field and stores the values; and
a portion that detects a generation sequence of the picture signal of the n-th field by using the two-time statistic value for the picture signal of the n-th field and the three one-time statistic values for the picture signals of the n-th field, the (n−1)th field and the (n−2)th field.

15. An interlace/progressive conversion device for converting an interlace picture signal into a progressive picture signal, comprising:
a first portion that performs motion detection for each pixel by a two-field difference with respect to a picture signal of the n-th field (n is an integer) so as to obtain a two-time statistic value from the number of pixels having a motion;
a second portion that obtains a one-time statistic value from an accumulated value of one-field differences for pixels that are detected to have a motion by the two-field difference with respect to the picture signal of the n-th field;
a third portion that determines one-time statistic values for the picture signals of the (n−1)th field and the (n−2)th field and stores the same;
a fourth portion that compares each of the two-time statistic value of the picture signal of the n-th field and the three one-time statistic values of the picture signals of the n-th field, the (n−1)th field and the (n−2)th field with a threshold value so as to decide whether or not a generation sequence of the picture signal of the n-th field is an edit sequence in which a progressive picture is edited for generation, in accordance with values thereof; and
a fifth portion that generates one frame by combining picture signals of two neighboring fields among the n-th field, the (n−1)th field and the (n−2)th field and delivers the generated frame as a progressive picture signal, if it is decided that the generation sequence of the n-th field is the edit sequence.

16. An interlace/progressive conversion device comprising:
a detection device according to claim 12;
a 32 pull down sequence detection device that detects a 32 pull down sequence;
a 22 pull down sequence detection device that detects a 22 pull down sequence; and
a conversion device that converts an interlace picture into a progressive picture in accordance with the generation sequence generated by the corresponding detection device.

17. An interlace/progressive conversion device comprising:
a detection device according to claim 13;
a 32 pull down sequence detection device that detects a 32 pull down sequence;
a 22 pull down sequence detection device that detects a 22 pull down sequence; and
a conversion device that converts an interlace picture into a progressive picture in accordance with the generation sequence generated by the corresponding detection device.

18. An interlace/progressive conversion device comprising:
a detection device according to claim 14;
a 32 pull down sequence detection device that detects a 32 pull down sequence;
a 22 pull down sequence detection device that detects a 22 pull down sequence; and
a conversion device that converts an interlace picture into a progressive picture in accordance with the generation sequence generated by the corresponding detection device.
